(19) United States
(12) Patent Application Publication
(10) Pub. No.: US 2019/0122554 A1
(43) Pub. Date: Apr. 25, 2019

(54) SMART PARKING MANAGEMENT AND NAVIGATION SYSTEM

(71) Applicant: KING ABDULLAH UNIVERSITY OF SCIENCE AND TECHNOLOGY, Thuwal (SA)

(72) Inventor: Mohamed SAADELDIN, Thuwal (SA)

(21) Appl. No.: 16/090,904

(22) PCT Filed: May 2, 2017
(86) PCT No.: PCT/IB2017/052540

§ 371 Date: Oct. 3, 2018

Related U.S. Application Data
(60) Provisional application No. 62/331,042, filed on May 3, 2016.

(51) Int. Cl. G08G 1/14; G08G 1/0969; G06Q 10/02; G06Q 20/08

(52) U.S. Cl. CPC G08G 1/144; G06Q 20/085; G06Q 10/02; G08G 1/0969

(57) ABSTRACT

Various examples are provided for smart parking management, which can include navigation. In one example, a system includes a base station controller configured to: receive a wireless signal from a parking controller located at a parking space; determine a received signal strength indicator (RSSI) from the wireless signal; and identify a presence of a vehicle located at the parking space based at least in part on the RSSI. In another example, a method includes receiving a wireless signals from a base station controller and a parking controller located at a parking space; determining RSSIs from the wireless signals; and determining a location of the mobile computing device in a parking facility based at least in part on the RSSIs. In another example, a RSSI can be received, a parking occupancy can be determined using the RSSI, and an electronic record can be updated based on the parking occupancy.

### CROSS REFERENCE TO RELATED APPLICATIONS

This application claims priority to, and the benefit of, co-pending U.S. provisional application entitled “Smart Parking Management and Navigation System” having Ser. No. 62/331,042, filed May 3, 2016, which is hereby incorporated by reference in its entirety.

### BACKGROUND

Often times, there are numerous vehicles traveling around a city during peak periods of a day. In most areas, there are different parking facilities available for vehicle parking throughout the city. Each parking facility may possess a different number of parking spaces. In addition, vehicles are entering and existing parking facilities in an unpredictable manner.

### SUMMARY

Aspects of the present disclosure are related to parking management. This can facilitate identifying and/or reserving parking spaces. Navigation information can be provided to a parking space.

In one or more aspects, a smart parking space system can comprise a base station controller configured to: receive a wireless signal from a parking controller located at a parking space; determine a received signal strength indicator (RSSI) from the wireless signal; and identify a presence of a vehicle located at the parking space based at least in part on the RSSI. In various aspects, the base station controller is further configured to communicate a parking occupancy associated with the parking space to a remote computing device in response to the identification of the presence of the vehicle. Identifying the presence of the vehicle located at the parking space can further comprise determining that the RSSI decreases below a threshold. In one or more aspects, the parking controller can comprise a first parking controller. Identifying the presence of the vehicle located at the parking space can further be based at least in part on the RSSI received from a second parking controller and the first parking controller. In various aspects, the wireless signal can comprise a unique controller identifier associated with the parking controller transmitting the wireless signal. The base station controller can be located at a parking facility. The wireless signal is received over a Bluetooth protocol.

In one or more aspects, a method can comprise receiving, using a mobile computing device, a first wireless signal from a base station controller and a second wireless signal from a parking controller located at a parking space; determining, using the mobile computing device, a first receive signal strength indicator (RSSI) from the first wireless signal and a second RSSI from the second wireless signal; and determining, using the mobile computing device, a location of the mobile computing device in a parking facility based at least in part on the first RSSI and the second RSSI. The method can further comprise encoding, using the mobile computing device, for display a user interface on a display device associated with the mobile computing device. The user interface can include a plurality of vacant parking spaces. In various aspects, the user interface can include a navigation instruction to one of the plurality of vacant parking spaces. The user interface can include a parking space location of one of the plurality of vacant parking spaces on a parking facility map. The method can further comprise transmitting, using the mobile computing device, a reservation request for one of the plurality of vacant parking spaces. In some aspects, determining the location of the mobile computing device in the parking facility can further be based at least in part on a sensor device associated with the mobile computing device.

In one or more aspects, a non-transitory computer-readable medium can embody a program executable in at least one computing device. Execution of the program can cause the at least one computing device to: receive, from a base station controller, a receive signal strength indicator (RSSI) associated with a wireless signal transmitted from a parking controller located at a parking space; determine a parking occupancy associated with the parking space based at least in part on the RSSI, the parking occupancy being used to indicate a presence of a vehicle located at the parking space; and update an electronic record associated with the parking facility based at least in part on the parking occupancy. In various aspects, the program, when executed, can cause the at least one computing device to: determine a vacant parking space from the electronic record; and in response to receiving a request, transmit the vacant parking space to a client device. Transmitting the vacant parking space can further comprise rendering for display on the client device a user interface that includes a location of the vacant parking space and a map of the location. The program, when executed, can cause the at least one computing device to: receive a reservation request associated with the vacant parking space from the client device; and update the electronic record in response to the reservation request. In some aspects, the program, when executed, causes the at least one computing device to conduct a payment transaction associated with the parking space with a client device. The wireless signal can further comprise a controller identifier associated with the parking controller.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a networked environment, according to various embodiments of the present disclosure.

FIG. 2 is a block diagram illustrating an example of a vehicle being detected in a parking space using a wireless signal according to various embodiments of the present disclosure.

FIG. 3A is a block diagram illustrating an example of the parking controller in FIG. 1 and FIG. 2 according to various embodiments of the present disclosure.

FIG. 3B is a block diagram illustrating an example of the base station controller in FIG. 1 and FIG. 2 according to various embodiments of the present disclosure.

FIG. 4 is a flowchart illustrating an example of certain functionality implemented by portions of the parking management application executed in a computing environment in the networked environment of FIG. 1 according to various embodiments of the present disclosure.

FIG. 5 is a schematic block diagram that illustrates an example computing environment employed in the networked environment of FIG. 1 according to various embodiments.

The drawings illustrate only exemplary embodiments and are therefore not to be considered limiting of the scope of the embodiments described herein, as other equally effective embodiments are within the scope and spirit of this disclosure. The elements and features shown in the drawings are not necessarily drawn to scale, emphasis instead being placed upon clearly illustrating the principles of the exemplary embodiments. Additionally, certain dimensions or positionings may be exaggerated to help visually convey certain principles. In the drawings, similar references numerals between figures designates like or corresponding, but not necessarily identical, elements.

### DETAILED DESCRIPTION

Disclosed herein are various embodiments of methods and systems related to parking management, including identifying occupied parking spaces and reserving empty parking spaces. For example, when an individual is looking for an available parking space for their vehicle, the various embodiments of the present disclosure can be used to assist in identifying a location of an available parking space at respective parking facilities. The various embodiments of the present disclosure can identify whether a parking space is occupied by using a wireless signal received from a parking controller located at the parking space. Specifically, a vehicle presence can be identified based on a receive signal strength indicator (RSSI) measurement of the wireless signal sent by the parking controller. In some situations, the parking controller for the parking space can operate in a beacon mode, where the parking controller can periodically broadcast a wireless signal that includes a unique identifier. One or multiple base stations located within a proximity of the parking controller can receive the wireless signal and can determine whether a vehicle is located at the parking space from the RSSI measurements associated with the wireless signals.

Further, a particular base station can transmit the RSSI data and/or parking occupancy data to a computing server. In some embodiments, among others, a gateway base station can aggregate the RSSI data and/the parking occupancy data from multiple base stations and transmit the data to the computer server. In other embodiments, the multiple base stations can transmit the data over a network, for example over a Wi-Fi or cellular network, to the computing server.

In the various embodiments of the present disclosure, the computing server can maintain an electronic parking record of the parking occupancy of multiple parking spaces at various parking facilities. In other words, the electronic parking record documents in real-time or near real-time parking vacancies and occupancies associated with individual parking spaces. In some situations, an individual may desire to reserve a parking spot for a particular period of time at a specific parking facility. The individual can render a parking management network site on a client device and transmit, using the client device, a parking reservation request for a particular parking facility to the computing server. Further, the parking management network site can be used to provide services such as conducting transactions for parking services, finding the nearest parking space, collecting real-time parking performance data, and providing parking performance data analysis.

In addition, the present disclosure relates to determining a location of a client device associated with a user in a parking facility. RSSI data received from one or multiple parking controllers and the base stations can be used to determine the location of the client device. Moreover, one or multiple sensor devices associated with the client device can assist with determining the location of the client device. With the location of the client device determined, the present disclosure can provide navigating instructions associated with the parking facility to the client device. Specifically, the client device can be provided with instructions used to navigate to a respective vacant parking space or with instructions used to navigate to a parking space of a parked vehicle associated with the user of the client device.

The present disclosure of the various embodiments has several advantages over existing implementations. For example, the various embodiments of the present disclosure can conduct traditional parking services, such as parking transactions, in a faster manner. In addition, the various embodiments can provide new services such as tracking whether each individual parking spot at a parking facility is occupied in real-time using wireless communication data. Thus, parking facilities can inform vehicle occupants of the number of available parking spaces and the location of available parking spaces within the parking facilities. In some situations, client devices can be provided with instructions for navigating to a particular parking space such as a vacant parking space or for returning to a parking space occupied by the user. These functionality features enable vehicle occupants to quickly navigate to a particular parking space, and in some cases, avoid certain parking facilities entirely because no parking is determined to be available. Accordingly, the various embodiments of the present disclosure can reduce traffic and save gas because vehicle occupants can spend less time on identifying available parking.

In addition, the various embodiments of the present disclosure can be implemented with less infrastructure than existing solutions. As a result, installation costs and installation time may be lowered. Additionally, the various embodiments of the present disclosure have greater flexibility with deployment scenarios. For example, the various embodiments can be deployed at parking facilities that are indoor and/or outdoor.

In the following paragraphs, the embodiments are described in further detail by way of example with reference to the attached drawings. In the description, well known components, methods, and/or processing techniques are omitted or briefly described so as not to obscure the embodiments. Turning now to the drawings, a general description of exemplary embodiments of a smart parking management and navigation system and its components are provided, followed by a discussion of the operation of the system.

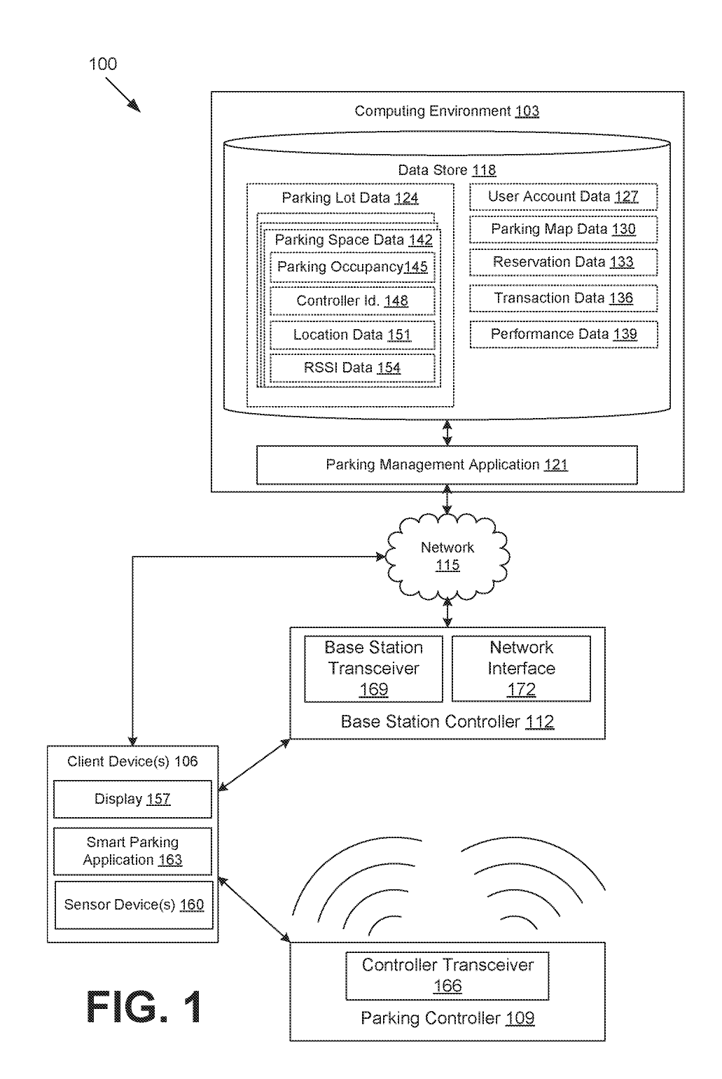

With reference to FIG. 1, shown is a networked environment 100 according to various example embodiments. The networked environment 100 includes a computing environment 103, a client device 106, a parking controller 109, a base station controller 112, which are in data communication via a network 115. The network 115 includes, for example, the Internet, intranets, extranets, wide area networks (WANs), local area networks (LANs), wired networks, wireless networks, or other suitable networks, etc., or any combination of two or more such networks.

The computing environment 103 may comprise, for example, a server computer or any other system providing computing capability. Alternatively, the computing environment 103 may employ a plurality of computing devices arranged, for example, in one or more server or computer banks or other arrangements. Such computing devices may be located in a single installation or distributed among different geographical locations. For example, the computing environment 103 may include a plurality of computing devices that together comprise a cloud computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data may be stored in a data store 118 that is accessible to the computing environment 103. In certain embodiments, the data store 118 may be representative of or comprise a plurality of data stores 118. The data stored in the data store 118, for example, may be associated with operation or execution of the various applications, components, and/or functional elements described below.

The components executed on the computing environment 103, for example, include a parking management application 121, and other applications, services, processes, systems, engines, or functionality not discussed in detail herein. The parking management application 121 can be executed to interact with an electronic parking record database that documents in real-time parking vacancies and occupancies associated with individual parking spaces. In addition, the parking management application 121 can be used to provide services such as reserving parking spaces, conducting parking transactions, finding the nearest parking space, providing navigation instructions, collecting real-time parking performance data, and and/or providing parking performance data analysis.

The data stored in the data store 118 includes, for example, parking lot data 124, user account data 127, parking map data 130, reservation data 133, transaction data 136, performance data 139, and potentially other data. Parking lot data 124 can represent data associated with one or multiple parking facilities. In particular, the parking lot data 124 can comprise parking space data 142 for individual parking spaces in a parking facility. In some embodiments, the parking lot data 124 can be stored in an electronic parking record such as a database. The electronic parking record can provide a record of which parking spaces are vacant, occupied, reserved, or other suitable statuses associated with a parking space. The parking space data 142 can comprise parking occupancy data 145, a controller identifier 148, location data 151 associated with the particular parking space, such as a latitude, a longitude, and an elevation, and RSSI data 154 associated with wireless signals transmitted by the parking controller 109. The parking occupancy data 145 can correspond to whether the parking space is occupied, vacant, or reserved. The parking space data 142 may also include user account data 127 to indicate which user is occupying the parking space. The controller identifier 148 can comprise data associated with a unique identifier associated with the parking controller 109. The RSSI data 154 can comprise RSSI measurement data of a power level present in a received RF wireless signal (e.g. a received message) by an antenna.

User account data 127 may comprise of data related to a plurality of users. For example, the user account data 127 may include a user profile associated with an individual user. The user profile can include a user name, a user address, vehicles associated with the user, and other user information. The user account data 127 may also include parking space data 142 to indicate which parking space the user is currently occupying or has reserved. Parking map data 130 can comprise a plurality of maps associated with individual parking facilities. Each one of the maps can include a map of the various parking spaces, an identifier for each parking space, and location data associated with each parking space. Reservation data 133 can comprise data associated with parking reservations. For example, reservation data 133 can include, for example, a reservation for a respective parking space on a particular day and time. The reservation may also include a period of time for which the parking space is reserved and a particular user associated with the reservation. The reservation data 133 may also include parking occupancy data 145 and user account data 127 to indicate which user is occupying a particular parking space. Transaction data 136 can comprise a record of parking transactions for parking services rendered.

The client device 106 is representative of a plurality of client devices that can be coupled to the network 115. The client device 106 can comprise, for example, a processor-based system such as a computer system. Each computer system can be embodied in the form of a laptop computer, personal digital assistant, cellular telephone, smartphone, web pad, tablet computer system, game console, electronic book reader, or wearable activity tracker, for example, without limitation. The client device 106 can include a display 157 and one or multiple sensor devices 160. The display 157 can comprise, for example, one or more devices such as liquid crystal display (LCD) displays, gas plasma-based flat panel displays, organic light emitting diode (OLED) displays, LCD projectors, or other types of display devices, etc. The sensor devices 160 can include, for example, at least one of an accelerometer, a gyroscope, an elevation sensor, a rotation sensor, and other suitable inertial measurement sensors.

The client device 106 may be configured to execute various applications such as a smart parking application 163 and/or other applications. The smart parking application 163 can be executed in a client device 106, for example, to access network content served up by the computing environment 103 and/or other servers, thereby rendering a user interface on the display 157. The smart parking application 163 can, for example, correspond to a browser, a mobile application, etc., and the user interface can correspond to a network page, a mobile application screen, etc. The client device 106 may be configured to execute applications beyond the smart parking application 163 such as, for example, browsers, mobile applications, email applications, social networking applications, and/or other applications.

The parking controller 109 can be representative of a plurality of parking controllers. The parking controller 109 can comprise a controller transceiver 166 that may include a wireless transceiver. The wireless transceiver can be configured to communicate using various wireless protocols such as a Bluetooth, Bluetooth Low Energy, and other suitable RF wireless protocols. The wireless transceiver can also be used to communicate using a propriety RF wireless protocol. The controller transceiver can be used to communicate with the client device 106. The parking controller 109 may comprise light weight sensors such as a magnetometer, an ambient light sensor, a temperature sensor, and other suitable sensors. Each parking controller 109 can be located within the confines of a parking space. As one skilled in the art can appreciate, a parking facility can have multiple parking controllers 109, where each parking controller 109 can be positioned at a parking space.

The networked environment 100 also includes the base station controller 112. The base station controller 112 can be representative of a plurality of base station controllers that may be coupled to the network 115. The base station controller 112 may comprise a base station transceiver 169 and a network interface 172. The base station transceiver 169 can include a wireless transceiver configured to communicate using various wireless protocols such as a Bluetooth, Bluetooth Low Energy, and other suitable RF wireless protocols. The base station transceiver 169 can also be used to communicate using a propriety protocol. The base station transceiver 169 can be used to communicate with the client device 106 and the parking controller 109. Each base station controller 112 can be located within a parking facility. As one skilled in the art can appreciate, a parking facility can have multiple base station controllers 112, where each base station controller 112 can be positioned within a proximity of one or multiple parking controllers 109. The network interface 172 can be used to communicate over the network 115. In one embodiment, the network interface 172 can be used to communicate over a wireless network, such as Wi-Fi.

Next, a general description of the operation of the various components of the networked environment 100 is provided. To begin, a parking controller 109 can be in wireless data communication with a base station controller 112. In one embodiment, among others, the parking controller 109 may be positioned on the ground within the confines of a parking space. The parking controller 109 can broadcast on a periodic interval a wireless signal that includes the controller identifier 148. In response to receiving the wireless signal, the base station controller 112 can determine the controller identifier 148 and the RSSI associated with the wireless signal. In some embodiments, the base station controller 112 can store the controller identifier 148 and the RSSI. The base station controller 112 can determine whether the RSSI is below a RSSI threshold. In response to the RSSI being below the RSSI threshold, the base station controller 112 can identify the parking space as being occupied by a vehicle.

For example, as a vehicle moves to a parking space, the vehicle obstructs the wireless signals between the parking controller 109 located at the parking space and the base station controller 112. In particular, the obstruction decreases the RSSI received by the base station controller 112. In response to the RSSI being below the RSSI threshold, the base station controller 112 can indicate that a vehicle is located at the parking space.

After the presence of a vehicle has been detected, the base station controller 112 can communicate parking space data 142 to the computing environment 103. For example, the parking space data 142 can indicate in real-time or near real-time that the parking space is occupied. In addition, the parking space data 142 may include the controller identifier 148 and a time stamp indicating when the vehicle was detected at the parking space. The parking management application 121 may receive the parking space data 142 and store it in the data store 118.

The present disclosure also relates to identifying the location of a user within a parking facility and providing navigating instructions to a particular location, such as a parked vehicle location. As a non-limiting example, when the client device 106 enters an area within a proximity of the parking controller 109, the client device 106 can communicate with the parking controller 109. In one embodiment, among others, the client device 106 can receive a first wireless signal from the parking controller 109 and determine a first RSSI measurement from the first wireless signal. The first wireless signal can also include the controller identifier 148. The client device 106 can determine the location of the parking controller 109 based on the controller identifier 148. In particular, the client device 106 can obtain the location of the parking controller 109 by using a look-up table or requesting the location from the parking management application 121. The client device 106 can then estimate its location with respect to the known location of the parking controller 109 based on the first RSSI measurement. The client device 106 can also receive a second wireless signal from the base station controller 112 and determine a second RSSI measurement from the second wireless signal. The client device 106 can determine the location of the base station controller 112 using similar methods for determining the location of the parking controller 109. The client device 109 can determine its location on a parking garage map by triangulating its location based on the first RSSI measurement, the second RSSI measurement, and the known locations of the parking controller 109 and the base station controller 112. Accordingly, in some embodiments, the client device 106 can determine its location with greater precision by receiving RSSI measurements from multiple parking controllers 109 and base station controllers 112 and determining its location with respect to the known locations of these controllers.

In another embodiment, the client device 106 can receive the wireless signal from the parking controller 109. The wireless signal may include the controller identifier 148. The client device 106 can use a lookup table stored in its data store to determine the location of the parking controller 109 or request the location from the parking management application 121. In addition, the client device 106 may also receive the location of the parking controller 109 from the wireless signal.

In addition, the parking management application 121 can be used to identify empty parking spaces by analyzing parking lot data 124 associated with a parking facility. For example, an occupant of the vehicle may be near a particular parking facility and may desire assistance with finding a parking space. The vehicle occupant may use a client device 106 to identify available parking spaces using the smart parking application 163. The smart parking application 163 can cause the client device to transmit a request for available parking spaces. The request may specify a particular parking facility or a certain geographical area. In some embodiments, the smart parking application 163 can transmit location data associated with the present location of the client device 106 via one of the sensor devices 160, e.g. by receiving data from a GPS receiver. In response to receiving the request, the parking management application 121 can determine and transmit which parking spaces are currently available or, in some cases, parking spaces that will become available at a later time.

Upon receiving the parking lot data 124, the smart parking application 163 can be used to render on a user interface a map that includes available parking spaces in the area. For each individual parking space, the user interface may include the location data 151 associated with a certain parking space, a parking rate, and whether the parking space can be reserved. In some cases, the current location of the client device 106 can also be indicated on the user interface. For example, the nearest available parking space can be indicated on the user interface and navigating instructions to the parking space can be rendered. In some embodiments, the client device 106 can provide the location data 151 of the parking space to an autonomous vehicle, and the autonomous vehicle can navigate to the parking space.

In another non-limiting example, the vehicle occupant may use the smart parking application 163 to reserve an available parking space. In this case, the smart parking application 163 can transmit a reservation request for an identified parking space. Upon receipt of the reservation request, the parking management application 121 can then process the reservation request and store the appropriate data as reservation data 136.

Upon reaching the parking lot and completing parking the vehicle, the smart parking application 163 can ask the user to confirm its parking status and save its location. This will allow the user to navigate back to the vehicle. The smart parking application 163 may share this information with the parking management application 121.

In some embodiments, each parking controller 109 can be used to collect data associated with vehicle parking. For example, the parking controller 109 can store data associated with a length of time that a vehicle has been parked in the parking space and transmit the data to the base station controller 112, which can transmit the data to the computing environment 103.

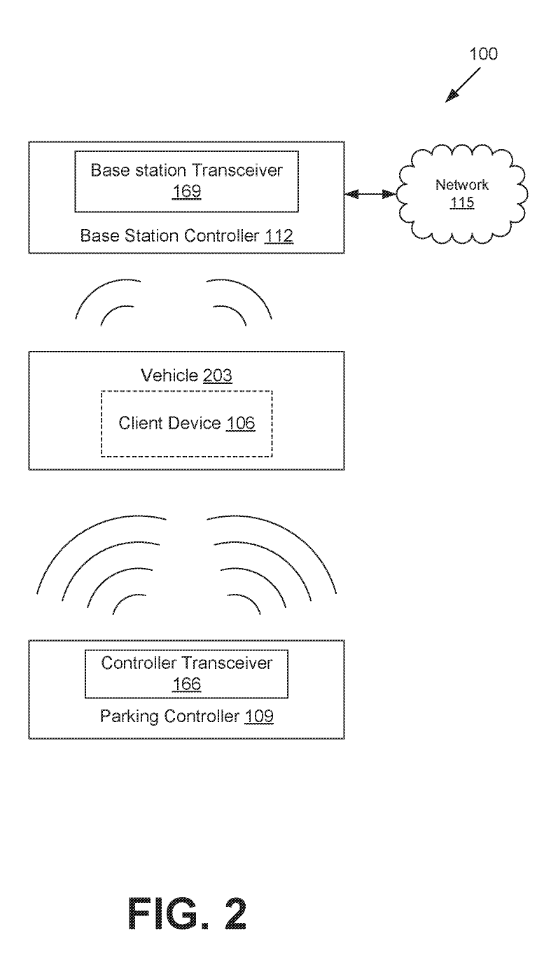

With respect to FIG. 2, shown is a block diagram illustrating an example of a vehicle 203 being detected in a parking space using a wireless signal. As discussed above, the base station controller 112 is in data communication with the parking controller 109. As a non-limiting example, the base station transceiver 169 may be in wireless data communication with the parking controller 109 using a Bluetooth protocol such as Bluetooth Low Energy (BLE). The parking controller 109 can be configured to transmit a wireless signal to the base station controller 112 on a periodic interval. The wireless signal can comprise the controller identifier 148 associated with the parking controller 109. From the wireless signal, the base station controller 112 can also determine a RSSI measurement associated with the wireless signal. The RSSI measurement can be stored as RSSI data 154 for the respective parking controller 109 that transmitted the wireless signal. In some embodiments, the base station controller 112 can determine the RSSI measurement is below a RSSI threshold. As illustrated in FIG. 2, the vehicle 203 obstructs a wireless transmission path between the base station controller 109 and the parking controller 109. This obstruction can cause the RSSI measured by the base station controller 112 to decrease. In some embodiments, a RSSI threshold can be configured to represent a vehicle obstructing the parking controller 109 at the parking space. Accordingly, when the RSSI measurements decrease below the RSSI threshold, the base station controller 112 can transmit parking occupancy 145 data to the computing environment 103. The parking occupancy data 145 can include data that indicates that the vehicle 203 is occupying the parking space.

In some embodiments, the base station controller 112 may determine that the vehicle 203 is occupying the parking space based on RSSI measurements received from multiple parking controllers 109. For example, when the vehicle 203 occupies a particular parking space, the RSSI measurements from a nearby parking controller may also be affected. In other words, the base station controller 112 may determine that the vehicle 203 is occupying a particular parking space based on the RSSI measurements from multiple nearby parking controllers.

In some situations, the base station controller 112 may not receive a wireless signal from the parking controller 109. These situations may arise from the presence of the vehicle 203 entirely or nearly entirely obstructing the wireless signal from the base station controller 112. In other situations, the parking controller 109 may be malfunctioning.

As one non-limiting example, the base station controller 112 may not receive a wireless signal from the parking controller 109 for a preconfigured time period. After the time period has expired, the base station controller 112 can determine whether the RSSI measurements from nearby parking controllers have decreased. Based on the RSSI measurements from nearby parking controllers, the base station controller 112 can determine that either a vehicle is parked at the parking space or that the parking controller 109 is malfunctioning.

In another non-limiting example, after the time period has expired, the base station controller 112 can transmit a command to the parking controller 109 to transmit a reply wireless signal. After a second time period has expired, the base station controller 112 may determine that the parking controller 109 is malfunctioning.

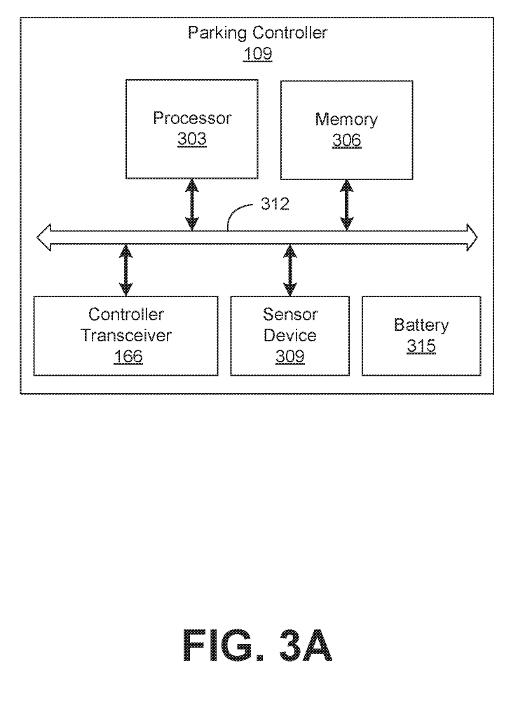

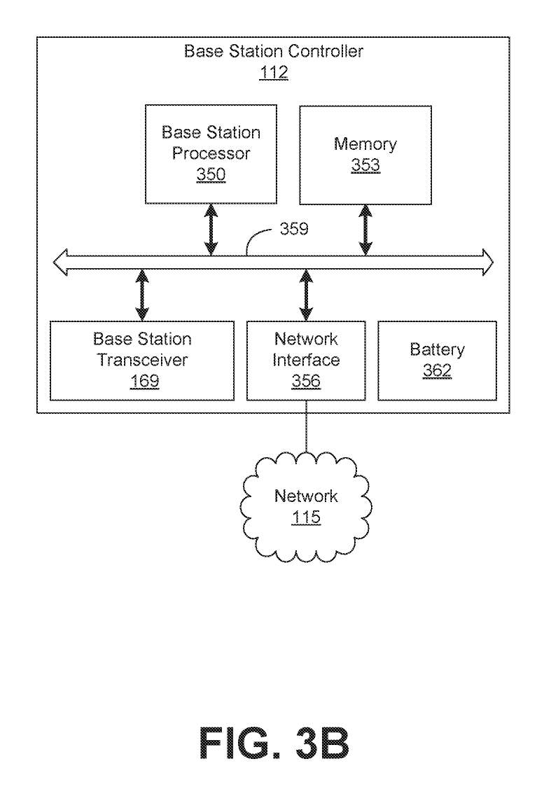

With reference to FIG. 3A, shown is a block diagram example of the parking controller 109 in FIG. 1 and FIG. 2. As shown in FIG. 3A, the parking controller 109 may comprise, for example, a processor 303, a memory 306, a sensor device 309, and the controller transceiver 166, which are in data communication via an interface 312. The sensor device 309 may comprise various sensory components such as an infrared device, a motion sensor, a magnetometer, an ambient light sensor, a temperature sensor, and other suitable sensor devices. The parking controller 109 may comprises a power circuit that distributes power to the various components of the parking controller. In some embodiments, the power circuit may include a battery 315 and associated charge/discharge circuitry. In some embodiments, the power circuit can comprise energy harvesting components used to generated electrical energy. The generated electrical energy can be stored in the battery 315 and/or applied to various components of the parking controller 109.

With reference to FIG. 3B, shown is a block diagram example of the base station controller 112 in FIG. 1 and FIG. 2. As shown in FIG. 3B, the base station controller 112 can comprise, for example, a base station processor 350, memory 353, the base station transceiver 169, and a network interface 356, which are in data communication via a base station interface 359. The network interface 356 can represent various components configured to communicate over the network 115. For example, the network interface 356 can include one or more transceivers for communicating via a wireless network, a wired network, a mobile cellular network, a propriety communication network, or other suitable data communication networks.

The base station controller 112 can comprise a power circuit that distributes power to the various components of the base station controller 112. In some embodiments, the power circuit may include a battery 362 and associated charge/discharge circuitry.

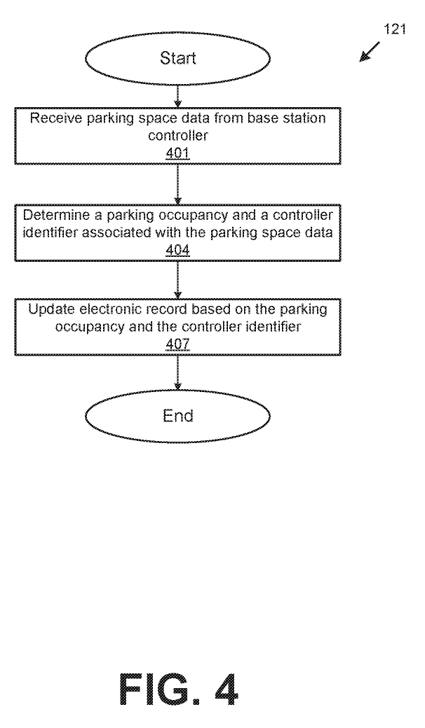

Referring next to FIG. 4, shown is a flowchart that provides one example of the operation of a portion of the parking management application 121 according to various embodiments. It is understood that the flowchart of FIG. 4 provides merely an example of the many different types of functional arrangements that may be employed to implement the operation of the portion of the parking management application 121 as described herein. As an alternative, the flowchart of FIG. 4 may be viewed as depicting an example of steps of a method implemented in the computing environment 103 (FIG. 1) according to one or more embodiments.

Beginning at 401, the parking management system 121 can receive parking space data 142 from one of the parking controllers 109. The parking controller 109 may transmit data to the computing environment 103 on a periodic time interval, in response to a command from the parking management application 121, in response to a command from the base station controller 112, or at other suitable intervals. The controller identifier 148 can represent a unique identifier for the parking controller 109. In some embodiments, the parking controller 109 and/or the base station controller 112 may obtain user account data 127 from the client device 106 associated with the vehicle detected at the parking space. The user account data 127 can be used to identify a user. The base station controller 112 can transmit the user account data 127 along with the parking space data 142. Next, at 404, the parking management application 121 can determine a parking occupancy associated with the parking space and the controller identifier 148 based at least in part on the received data. Subsequently, at 407, the parking management application 121 can update an electronic parking record database by storing the parking occupancy data 145 and the controller identifier 148. The electronic parking record database provides real-time or near real-time access to which parking spaces are vacant, occupied, reserved, or other suitable conditions associated with the parking space. Thereafter, the parking management application 121 ends as shown. The parking management application 121 may associate and link the controller identifier 148 to the user account data 127 in order to identify which user is occupying a specific parking space. This can be used to allow the user to navigate back to the vehicle and can also be used for applying parking rates and payment.

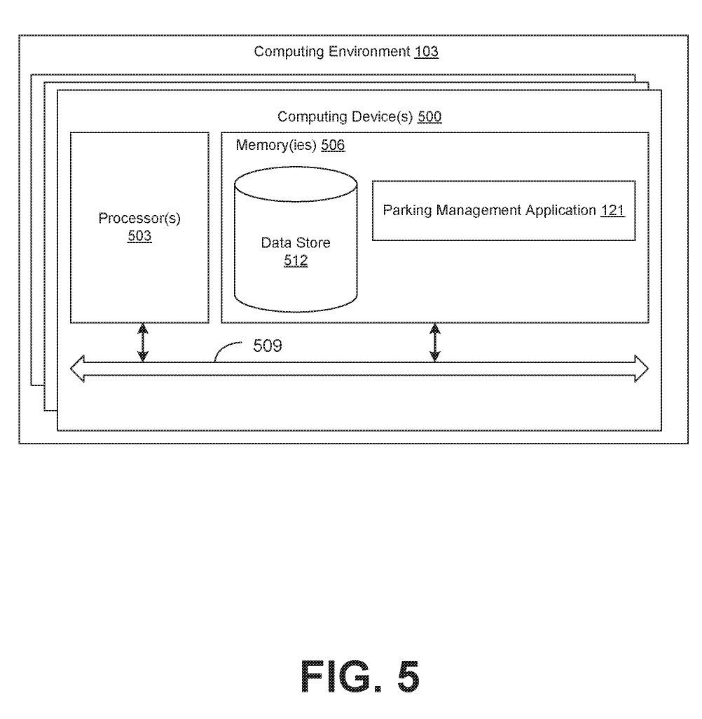

FIG. 5 illustrates a schematic block diagram of the computing environment 103 according to an example embodiment. The computing environment 103 includes one or more computing devices 500. Each computing device 500 includes at least one processor circuit, for example, having a processor 503 and a memory 506, both of which are coupled to a local interface 509. To this end, each computing device 500 may comprise, for example, at least one server computer or like device. The local interface 509 may comprise, for example, a data bus with an accompanying address/control bus or other bus structure as can be appreciated.

In various embodiments, the memory 506 stores data and software or executable-code components executable by the processor 503. For example, the 506 may store the parking management application 121, among other applications, as components for execution by the processor 503. The memory 506 may also store a data such as that stored in the data store 512 and other data.

It should be understood and appreciated that the memory 506 may store other executable-code components for execution by the processor 503. For example, an operating system may be stored in the memory 506 for execution by the processor 503. Where any component discussed herein is implemented in the form of software, any one of a number of programming languages may be employed such as, for example, C, C++, C#, Objective C, Java®, JavaScript, Perl, PHP, Visual Basic®, Python®, Ruby, Flash®, or other programming languages.

As discussed above, the memory 506 stores a number of software for execution by the processor 503. In this respect, the terms “executable” or “for execution” refer to software forms that can ultimately be run or executed by the processor 503, whether in source, object, machine, or other form. Examples of executable programs include, for example, a compiled program that can be translated into a machine code format and loaded into a random access portion of the memory 506 and executed by the processor 503, source code that can be expressed in an object code format and loaded into a random access portion of the memory 506 and executed by the processor 503, or source code that can be interpreted by another executable program to generate instructions in a random access portion of the memory 506 and executed by the processor 503, etc. An executable program may be stored in any portion or component of the memory 506 including, for example, a random access memory (RAM), read-only memory (ROM), magnetic or other hard disk drive, solid-state, semiconductor, or similar drive, USB flash drive, memory card, optical disc (e.g., compact disc (CD) or digital versatile disc (DVD)), floppy disk, magnetic tape, or other memory component.

In various embodiments, the memory 506 may include both volatile and nonvolatile memory and data storage components. Volatile components are those that do not retain data values upon loss of power. Nonvolatile components are those that retain data upon a loss of power. Thus, the memory 506 may comprise, for example, a random access memory (RAM), read-only memory (ROM), magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM may comprise, for example, a static random access memory (SRAM), dynamic random access memory (DRAM), or magnetic random access memory (MRAM), and/or other similar memory device. The ROM may comprise, for example, a programmable read-only memory (PROM), erasable programmable read-only memory (EPROM), electrically erasable programmable read-only memory (EEPROM), or other similar memory device.

Also, the processor 503 may represent multiple processors 503 and/or multiple processor cores and the memory 506 may represent multiple memories 506 that operate in parallel processing circuits, respectively or in combination. In such a case, the local interface 509 may be an appropriate network or bus that facilitates communication between any two of the multiple processors 503, between any processor 503 and any of the memories 506, or between any two of the memories 506, etc. The local interface 509 may comprise additional systems designed to coordinate this communication, including, for example, a load balancer that performs load balancing. The processor 503 may be of electrical or of some other available construction.

As discussed above, the parking management application 121 and the smart parking application 163 may be embodied in software or executable-code components for execution by general purpose hardware as discussed above. Alternatively the same may be embodied in dedicated hardware or a combination of software, general, specific, and/or dedicated purpose hardware. If embodied in such hardware, each can be implemented as a circuit or state machine, for example, that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart or process diagram of FIG. 4 is representative of certain processes, functionality, and operations of embodiments discussed herein. Each block may represent one or a combination of steps or executions in a process. Alternatively or additionally, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the processor 503. The machine code may be converted from the source code, etc. Further, each block may represent, or be connected with, a circuit or a number of interconnected circuits to implement a certain logical function or process step.

Although the flowchart or process diagram of FIG. 4 illustrates a specific order, it is understood that the order may differ from that which is depicted. For example, an order of execution of two or more blocks may be scrambled relative to the order shown. Also, two or more blocks shown in succession in FIG. 4 may be executed concurrently or with partial concurrence. Further, in some embodiments, one or more of the blocks shown in FIG. 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the parking management application 121, which comprises software or executable-code components can be embodied or stored in any tangible or non-transitory computer-readable medium or device for use by or in connection with an instruction execution system such as, for example, the processor 503. In this sense, the logic may comprise, for example, software or executable-code components that can be fetched from the computer-readable medium and executed by the instruction execution system. Thus, the instruction execution system may be directed by execution of the instructions to perform certain processes such as those illustrated in FIG. 4. In the context of the present disclosure, a “computer-readable medium” can be any medium that can contain, store, or maintain any logic, application, software, or executable-code component described herein for use by or in connection with an instruction execution system.

The computer-readable medium can comprise any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium may comprise a random access memory (RAM) including, for example, a static random access memory (SRAM), dynamic random access memory (DRAM), or magnetic random access memory (MRAM). In addition, the computer-readable medium may comprise a read-only memory (ROM), a programmable read-only memory (PROM), an erasable programmable read-only memory (EPROM), an electrically erasable programmable read-only memory (EEPROM), or other similar memory device.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

1. A smart parking space system, comprising:
a base station controller configured to:
receive a wireless signal from a parking controller located at a parking space;
determine a received signal strength indicator (RSSI) from the wireless signal; and
identify a presence of a vehicle located at the parking space based at least in part on the RSSI.

2. The smart parking space system of claim 1, wherein the base station controller is further configured to communicate a parking occupancy associated with the parking space to a remote computing device in response to the identification of the presence of the vehicle.

3. The smart parking space system of any of claim 1, wherein identifying the presence of the vehicle located at the parking space further comprises determining that the RSSI decreases below a threshold.

4. The smart parking space system of claim 1, wherein the parking controller comprises a first parking controller, and wherein identifying the presence of the vehicle located at the parking space is further based at least in part on the RSSI received from a second parking controller and the first parking controller.

5. The smart parking space system of claim 1, wherein the wireless signal comprises a unique controller identifier associated with the parking controller transmitting the wireless signal.

6. The smart parking space system of claim 1, wherein the base station controller is located at a parking facility.

7. The smart parking space system of claim 1, wherein the wireless signal is received over a Bluetooth protocol.

8. A method, comprising:
receiving, using a mobile computing device, a first wireless signal from a base station controller and a second wireless signal from a parking controller located at a parking space;
determining, using the mobile computing device, a first receive signal strength indicator (RSSI) from the first wireless signal and a second RSSI from the second wireless signal; and
determining, using the mobile computing device, a location of the mobile computing device in a parking facility based at least in part on the first RSSI and the second RSSI.

9. The method of claim 8, further comprising encoding, using the mobile computing device, for display a user interface on a display device associated with the mobile computing device.

10. The method of claim 9, wherein the user interface includes a plurality of vacant parking spaces.

11. The method of claim 10, wherein the user interface includes a navigation instruction to one of the plurality of vacant parking spaces.

12. The method of claim 10, wherein the user interface includes a parking space location of one of the plurality of vacant parking spaces on a parking facility map.

13. The method of claim 10, further comprising transmitting, using the mobile computing device, a reservation request for one of the plurality of vacant parking spaces.

14. The method of claim 8, wherein
determining the location of the mobile computing device in the parking facility is further based at least in part on a sensor device associated with the mobile computing device.

15. A non-transitory computer-readable medium embodying a program executable in at least one computing device, wherein the program, when executed, causes the at least one computing device to:
receive, from a base station controller, a receive signal strength indicator (RSSI) associated with a wireless signal transmitted from a parking controller located at a parking space;
determine a parking occupancy associated with the parking space based at least in part on the RSSI, the parking occupancy being used to indicate a presence of a vehicle located at the parking space; and
update an electronic record associated with the parking facility based at least in part on the parking occupancy.

16. The non-transitory computer-readable medium of claim 15, wherein the program, when executed, causes the at least one computing device to:
determine a vacant parking space from the electronic record; and
in response to receiving a request, transmit the vacant parking space to a client device.

17. The non-transitory computer-readable medium of claim 16, wherein transmitting the vacant parking space further comprises rendering for display on the client device a user interface that includes a location of the vacant parking space and a map of the location.

18. The non-transitory computer-readable medium of claim 16, wherein the program, when executed, causes the at least one computing device to:
receive a reservation request associated with the vacant parking space from the client device; and
update the electronic record in response to the reservation request.

19. The non-transitory computer-readable medium of claim 16, wherein the program, when executed, causes the at least one computing device to conduct a payment transaction associated with the parking space with a client device.

20. The non-transitory computer-readable medium of claim 16, wherein the wireless signal further comprises a controller identifier associated with the parking controller.
